(19) United States
(12) Patent Application Publication
(10) Pub. No.: US 2019/0251015 A1
(43) Pub. Date: Aug. 15, 2019

(54) MAINFRAME TESTING FRAMEWORK

(71) Applicant: CA, Inc., New York, NY (US)

(72) Inventors: JESSICA ANNE TONDA, CARNEGIE, PA (US); CHRISTOPHER LYNN BOEHM, Pittsburgh, PA (US); JASON ANDREW TUCKER, Pittsburgh, PA (US); DANIEL L. KELOSKY, Beaver Falls, PA (US); SUZANNE M. DIEZ, Sewickley, PA (US)

(21) Appl. No.: 15/896,475

(22) Filed: Feb. 14, 2018

(51) Int. Cl. G06F 11/36; G06F 8/33

(52) U.S. Cl. CPC G06F 11/3664; G06F 8/33; G06F 11/3688

(57) ABSTRACT

A mainframe testing framework is provided that permits users to execute and store API and/or service test logic for mainframe APIs or services on-platform and/or of platform, and to access the mainframe system to execute the test logic on an as-needed basis. An API/service to be tested is identified and a mainframe address space is created that hosts the API/service. A command syntax, a test command and a corresponding response are received by the mainframe address space. An automated test (stored on- or off-platform) is received that invokes execution of the test command. It then is determined if the corresponding response is received in response to execution of the test command.

### BACKGROUND

Automating applications and services for execution in mainframe computing environments involves a myriad of challenges ranging from simply how to communicate readily with an application or service itself, to the more complex question of how to easily conduct tests of a mainframe system application or service. Typically, mainframe application/service tests are developed and executed on-platform or developed off-platform and shipped on-platform so that the tests can be run on-platform when needed.

While mainframe systems can provide powerful and useful tools for many computing tasks, many mainframe systems (for instance, legacy mainframe systems) do not support newer client side tools that developers and users increasingly are familiar with using.

### SUMMARY

This Summary is provided to introduce a selection of concepts in a simplified form that are further described below in the Detailed Description. This Summary is not intended to identify key features or essential features of the claimed subject matter, nor is it intended to be used in isolation as an aid in determining the scope of the claimed subject matter.

Embodiments of the technology described herein are directed towards providing a testing framework to enable mainframe system developers and users to test mainframe applications and services. In particular, the mainframe testing framework permits users and developers to execute and store application/service test logic for testing mainframe applications or services both on-platform (e.g., in association with the mainframe computing system) and/or off-platform (e.g., in association with a client device that can communicate with the mainframe computing system) and to access the mainframe system to execute the test logic on an as-needed basis.

In other embodiments of the technology described herein, the mainframe testing framework can be parameterized and command-driven, can support a variety of execution environments (e.g., AMODE31/64, TASK/SRB, PROS/SUP, cross-memory, etc.), can support multiple programming languages (e.g., ASM, Metal/LE C, Java, etc), and can even provide ways to mock the entrance conditions for a mainframe system application or service to be tested (e.g., setting registers, and the like). Thus, test logic for mainframe applications or services can he developed in a programming language that differs from that of the mainframe application or service itself making it simpler, for instance, to add additional automated tests to legacy products.

### BRIEF DESCRIPTION OF THE DRAWINGS

Aspects of the technology presented herein are described in detail below with reference to the attached drawing figures, wherein:

FIG. 1 is a block diagram depicting an exemplary computing architecture for testing mainframe Application Programming Interfaces (APIs) or services, in accordance with some aspects of the technology described herein;

FIG. 2 is a is a flow diagram showing a method for testing a mainframe API or service, in accordance with some aspects of the technology described herein;

FIG. 3 is a flow diagram showing a method for creating a mainframe address space host and testing a mainframe API or service utilizing the created host, in accordance with some aspects of the technology described herein;

FIG. 4 is a flow diagram showing a method for creating a mainframe address space host and testing a mainframe API or service utilizing the created host, in accordance with some aspects of the technology described herein; and

FIG. 5 is a block diagram of an exemplary computing environment suitable for use in implementing embodiments of the present invention.

### DETAILED DESCRIPTION OF THE INVENTION

The subject matter of aspects of the present disclosure is described with specificity herein to meet statutory requirements. However, the description itself is not intended to limit the scope of this patent. Rather, the inventors have contemplated that the claimed subject matter also might be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

According to some aspects of the technology described herein, a mainframe test application framework can be provided that permits users and developers to execute and store Application Programming Interface (API) and/or service test logic for testing mainframe APIs or services both on-platform (e.g., on the mainframe computing system) and/or off-platform (e.g., on a client device that can communicate with the mainframe computing system) and to access the mainframe system to execute the test logic on an as-needed basis. Initially, at least one mainframe API or service for which testing is desired is identified (e.g., by a developer or user and a mainframe address space configured for hosting a test instance of the identified mainframe APRs) or service(s) is created. In some embodiments, multiple mainframe address spaces can be configured to each host one or more mainframe APIs or services for which testing is desired.

A command syntax is identified (e.g., by the developer or user) for each API or service for which testing is desired. A single command syntax can be utilized for multiple APIs or services to be tested or each test API or service to be tested can be associated with its own command syntax. At least one test command configured to invoke a desired functionality of the mainframe API or service to be tested is received. In exemplary embodiments, the command(s) is received in the identified command syntax. Also received is at least one corresponding response to be provided in response to issuance (or upon execution) of each received test command. Stated differently, a corresponding response is the response that a developer or user desires to invoke upon issuance or execution of a test command. In exemplary embodiments, the corresponding response(s) is received in the identified command syntax. In exemplary embodiments, the corresponding responses can be formatted as JSON responses so that they are human-readable and more easily parsed than other common response formats. Command syntaxes, commands, and corresponding responses can be input to a client device and communicated for execution to a mainframe address space hosting a test instance of a mainframe API(s) or service(s) for which testing is desired and/or can be received directly by the mainframe system without communication from a client device.

Once a command syntax, at least one command, and at least one corresponding response are received, a test of the hosted mainframe API or service can be conducted. As tests may be executed on-platform and off-platform, various test scenarios exist. In one exemplary scenario, suppose a mainframe system user desires to have a test automation stored on the mainframe system. In this instance, a test can be created and executed on the mainframe system and it can be manually verified that an expected corresponding response is received. Such manual verification can be performed utilizing a mainframe-based automation such as, without limitation, OPS/MVS® Event Management and Automationprovided by CA Technologies.

In another exemplary scenario, suppose a mainframe developer desires to have an automated test stored off-platform and executed by the mainframe system only as needed. In this instance, a test can be created off-platform (e.g., at a client device) and communicated to the mainframe system (utilizing, by way of example only, z/OS® Management Facility provided by. IBM®). Similarly, corresponding responses can be received from the mainframe system off-platform (e.g., at the client device) where it can be verified whether or not the expected output is received.

In yet another exemplary scenario, suppose a developer desires to fix a bug in an API or service and, accordingly, desires to easily be able to test changes without running automated tests. As the API or service is already hosted on the mainframe system in its own address space, the developer can easily log on (for instance, through TPX) and issue commands to that address space (potentially using SYSVIEW® Performance Management provided by CA Technologies) after rebuilding and/or compiling the code. The developer then can issue the desired command on the mainframe system and manually verify the expected output.

Accordingly, one embodiment of the present disclosure is directed to a computer-implemented method for testing a mainframe API or service, in accordance with some aspects of the technology described herein. At a mainframe address space hosting a mainframe test application, a command syntax for a mainframe API or service to be tested is received. At the mainframe address space, at least one test command configured for invoking a functionality of the mainframe API or service to be tested also is received. The at least one test command can be received in the command syntax. At the mainframe address space, at least one corresponding response is received, the corresponding response to be provided by the mainframe test application in response to issuance of the at least one test command. The at least one corresponding response can be received in the command syntax. The at least one test command is executed by the mainframe test application and the mainframe address space provides the at least one corresponding response based upon execution of the at least one test command.

Another embodiment of the present disclosure is directed to a computer-implemented method for creating a command-based mainframe address space hosting a mainframe test application that mocks an environment for executing a mainframe API or service to be tested. At the command-based mainframe address space, a command syntax for the mainframe API or service to be tested is received. At the command-based mainframe address space and in the command syntax, a test command configured for invoking a functionality of the mainframe API or service to be tested is received, as is a corresponding response to be provided, by the command-based mainframe address space, in response to execution of the test command. The test command is executed, by the command-based mainframe address space, and the mainframe test application provides the corresponding response based upon execution of the test command.

Yet another embodiment of the present disclosure is directed to a method for creating a mainframe address space host and testing a mainframe API or service utilizing the created host, in accordance with some aspects of the technology described herein. A mainframe address space is created that mocks an environment for executing a mainframe API or service to be tested. A Command Definition Table is generated that includes a plurality of test commands configured for invoking functionalities of the mainframe API or service to be tested and at least one corresponding response to be provided in response to execution of each of the plurality of test commands. The Command Definition Table can be generated in a defined command syntax. The Command Definition Table is loaded to the mainframe address space and at least one test command of the plurality of test commands is executed by the mainframe address space. At least one corresponding response of the plurality of corresponding responses is provided, by the command-based mainframe address space, based upon execution of the at least one test command provide, by the command-based mainframe address space.

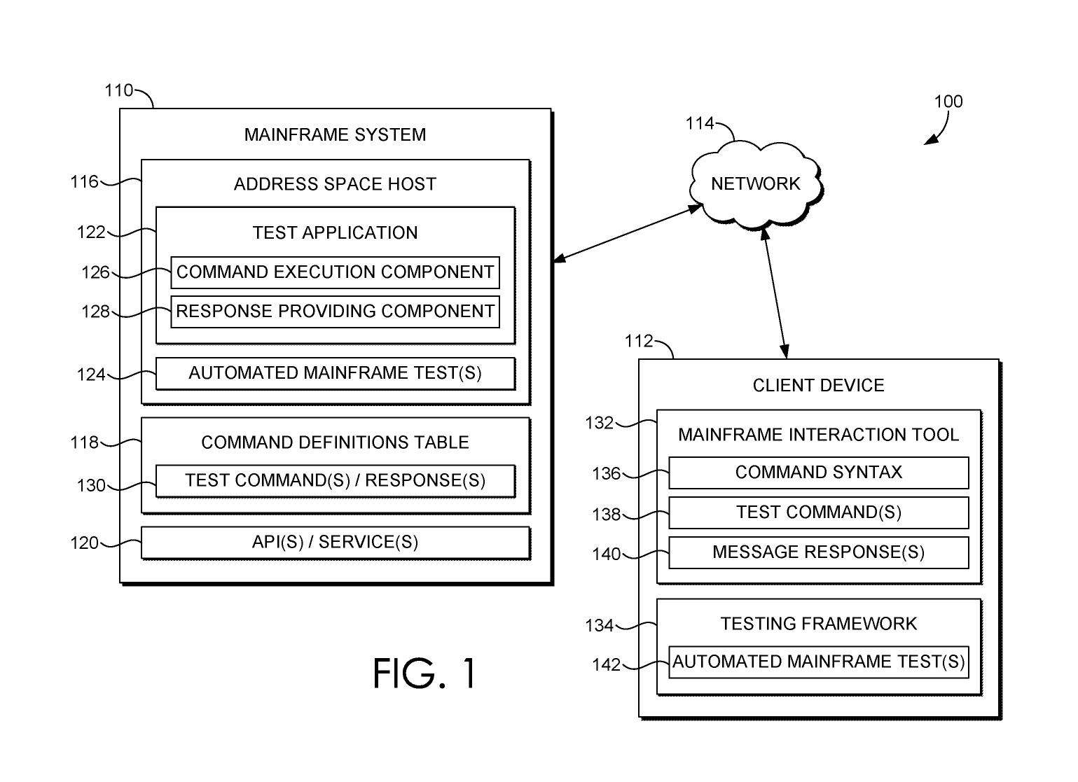

Referring now to the figures in general, and initially to FIG. 1 in particular, depicted is a block diagram of an exemplary computing architecture 100 in which some embodiments of the present disclosure can be employed. It should be understood that this and other arrangements described herein are set forth only as examples. Other arrangements and elements (e.g., machines, interfaces, functions, orders, and groupings of functions) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory,

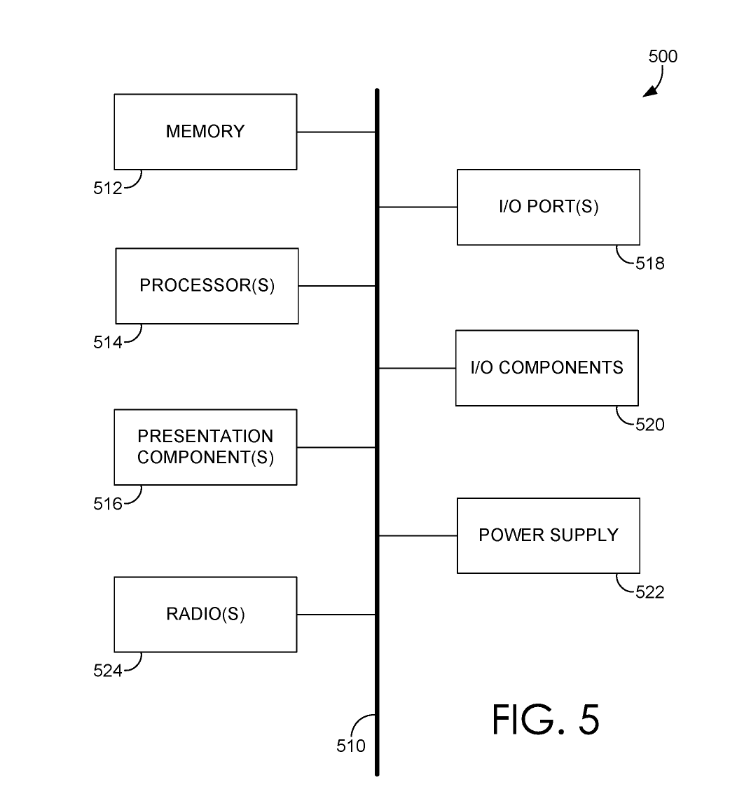

Among other components not shown, the exemplary computing architecture 100 includes a mainframe system 110 and a client device 112. Each of the mainframe system 110 and the client device 112 can be implemented via any type of computing device, such as the computing device 500 described below in connection to FIG. 5, for example. The illustrated components can communicate with each other via a network 114, which can include, without limitation, one or more local area networks (LANs) and/or wide area networks (WANs). Such networking environments are commonplace in offices, enterprise-wide computer networks, and intranets and, accordingly, are not further described herein. In exemplary implementations, the network 114 comprises the Internet and/or a cellular network, amongst any of a variety of possible public and/or private networks.

It should be understood that any number of mainframe systems and client devices can be employed within the exemplary computing architecture 100 within the scope of the present disclosure. Each can comprise a single device or multiple devices cooperating in a distributed environment. For instance, the mainframe system 110 can be provided via multiple devices arranged in a distributed environment that collectively provide the functionality described herein. Additionally, other components not shown also can be included within the distributed environment.

Initially, a developer or user identifies a mainframe API or service for which testing is desired. A host mainframe test application 122 for the API or service is created in an address space 116 of the mainframe system 110. The test application 122 includes a command execution component 126 and a response providing component 128, each of which is more fully described below.

As illustrated, the client device 112 includes a mainframe interaction tool 132 that comprises a command syntax receiving component 136, a test command receiving component 138 and a message response receiving component 140. The command syntax receiving component 136 of the client device 112 is configured to receive (for instance, via alphanumeric, audio, and/or video input, or the like) a command syntax for the mainframe API or service for which testing is desired. It is contemplated that the desired testing will be executed in the received command syntax. The test command receiving component 138 is configured to receive at least one test command configured for invoking a particular functionality of the mainframe API or service for which testing is desired. In exemplary embodiments, a received test command can be received in the command syntax that was received by the command syntax receiving component 136. The message response receiving component 140 is configured to receive, at least one corresponding response to be provided by the mainframe test application in response to execution of a test command received by the test command receiving component 138. Like the test command, in exemplary embodiments, the corresponding response can be received in the command syntax received by the command syntax receiving component 136. By way of example and not limitation, the corresponding responses can be JSON responses which can be human-readable and easily parsed and understood by, for instance, Mocha JS tests.

The command syntax, the test command(s) and the message response(s) then are communicated, by the mainframe interaction tool 132 of the client device 112, via the network 114, to the address space 116 of the mainframe system 110. It will be understood and appreciated by those having ordinary skill in the art that one or more of the command syntax, test command(s), and/or corresponding response(s) can be received directly by the mainframe computing system 110 rather than via communication through the network 114 from the client device 112 as illustrated. Any and all such variations, and any combination thereof, are contemplated to be within the scope of embodiments of the present invention.

As previously set forth, exemplary scenarios for utilizing embodiments of the present disclosure contemplate tests stored on the mainframe system 110, for instance, in association with the automated mainframe test(s) 124 of the test application 122 of the address space 116. In this instance, a test can be created and executed on the mainframe system 110 and it can be manually verified that an expected corresponding response is received. Such manual verification can be performed utilizing a mainframe-based automation such as, without limitation, OPS/MVS® Event Management and Automation provided by CA Technologies.

In other exemplary scenarios for utilizing embodiments of the present disclosure, it is contemplated that automated test can be stored off-platform (e.g., automated mainframe test(s) 142 of the testing framework 134 of the client device 112) and executed by the mainframe system 110 only as needed. In such an instance, a test can be created off-platform (e.g., at a client device 112) and communicated to the mainframe system 110 (utilizing, by way of example only, z/OS® Management Facility provided by IBM®). Similarly, corresponding responses can be received from the mainframe system 110 off-platform (e.g., at the client device) where it can be verified whether or not the expected output is received.

Regardless of where an automated test is created and stored, at e mainframe address space 116, the command execution component 126 of the test application 122 is configured to execute received test command(s). Similarly, at the mainframe address space 116, the response providing component 128 is configured to provide one or more responses corresponding to the executed test command(s).

in exemplary embodiments, test commands and corresponding responses 130 can be received as a Command Definition Table 118. The Command Definition Table includes a plurality of test commands and a plurality of corresponding responses received in the command syntax.

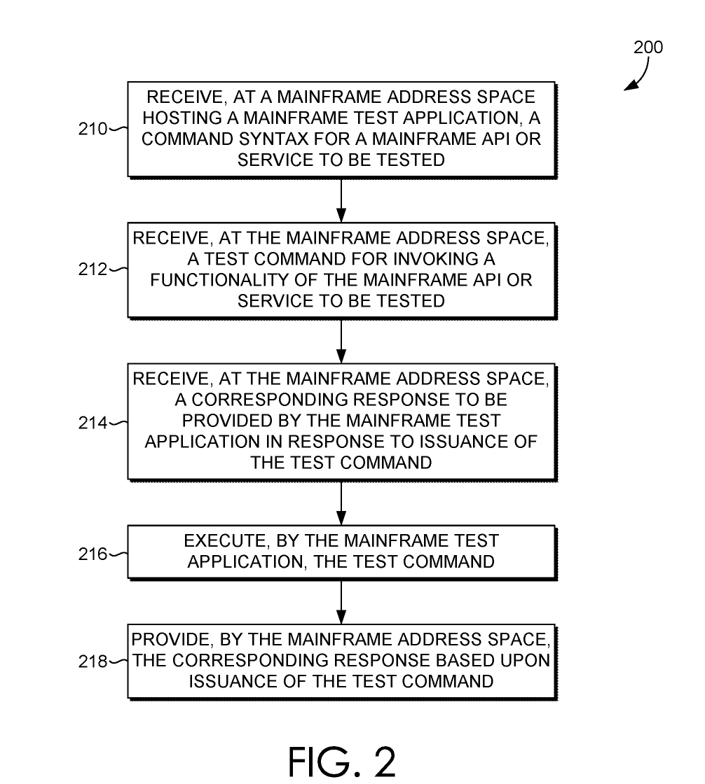

Turning now to FIG. 2, a flow diagram is provided illustrating one exemplary method 200 for testing a mainframe API or service. It is contemplated that each block or step of method 200 and other methods described herein comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a stand-alone application, a service or hosted service (stand-alone or in combination with another hosted service), or a plug-in to another product, to name a few.

At step 210, a command syntax for a mainframe API or service to be tested is received at a mainframe address space hosting a mainframe test application, for instance, at the address space 116 of the mainframe system 110 of FIG. 1. The API or service to be tested may be, by way of example only, the test application 122 hosted by the address space 116 of the mainframe system 110 of FIG. 1. At step 212, at least one test command is received at the mainframe address space (e.g., the mainframe address space 116 of FIG. I). The test command(s) can be configured for invoking a functionality of the mainframe API or service to be tested. The test command(s) is received in the command syntax received at step 210.

At step 214, at least one corresponding response to be provided by the mainframe test application in response to execution of the test command(s) is received at the mainframe address space (e.g., the mainframe address space 116 of FIG. 1). Like the test command(s), the corresponding response(s) can be received in the command syntax received at step 210. At step 216, the test command(s) is executed by the mainframe test application. At step 218, the corresponding response(s) received at step 214 is provided by the mainframe address space based upon execution of the at least one test command.

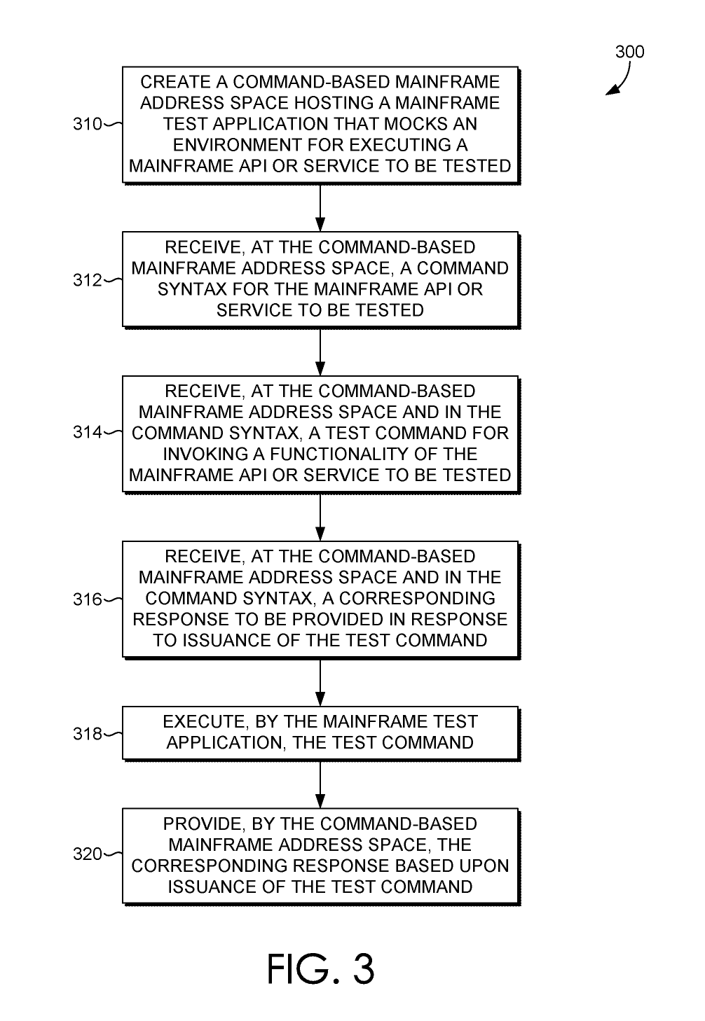

Turning now to FIG. 3, a flow diagram is provided illustrating one exemplary method 300 for creating a mainframe address space and testing a mainframe API or service utilizing the created host. It is contemplated that each block or step of method 300 and other methods described herein comprises a computing process that can be performed using any combination of hardware, firmware and/or software. For instance, various functions can be carried out by a processor executing instructions stored in memory. The methods can also be embodied as computer-usable instructions stored on computer storage media. The methods can be provided by a stand-alone application, a service or hosted service (stand-alone or in combination with another hosted service), or a plug-in to another product, to name a few.

At step 310, a command-based mainframe address space hosting a mainframe test application is created. The hosted mainframe test application can be configured to mock an environment for executing a mainframe API or service to be tested. At step 312, a command syntax for the mainframe API or service to be tested is received at the command-based mainframe address space. At step 314, a test command configured for invoking a functionality of the mainframe API or service to be tested is received at the command-based mainframe address space. The test command is received in the command syntax received at step 312.

At step 316, at least one corresponding response is received at the command-based mainframe address space, the corresponding response to be provided in response to execution of the test command. The corresponding response is received in the command syntax received at step 312. At step 318, the test command is executed by the command-based mainframe address space. At step 320, the corresponding response is provided by the mainframe test application based upon execution of the test command.

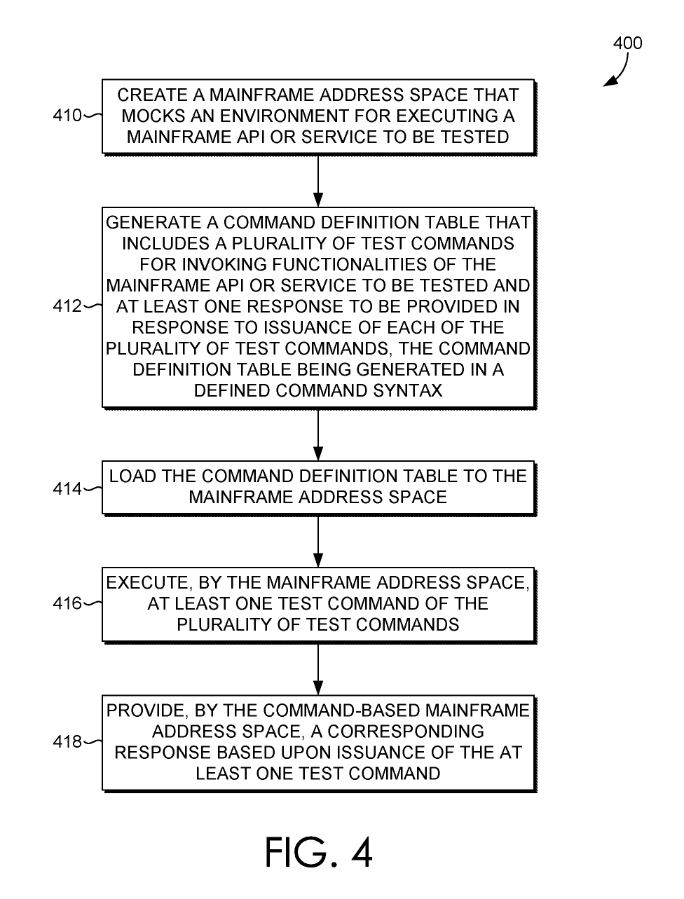

Turning now to FIG. 4, a flow diagram is provided illustrating one exemplary method 400 for creating a mainframe address space host and testing a mainframe API or service utilizing the created host. It is contemplated that each block or step of method 400 and other methods described herein comprises a computing process that can be performed using any combination of hardware, firmware and/or software. For instance, various functions can be carried out by a processor executing instructions stored in memory. The methods can also be embodied as computer-usable instructions stored on computer storage media. The methods can be provided by a stand-alone application, a service or hosted service (stand-alone or in combination with another hosted service), or a plug-in to another product, to name a few.

At step 410, a mainframe address space is created. The mainframe address space mocks an environment for executing a mainframe API or service to be tested. At step 412, a Command Definition Table is generated that includes a plurality of test command configured for invoking functionalities of the mainframe API or service to be tested and at least one corresponding response to be provided in response to execution of each of the plurality of test commands. The Command Definition Table is generated in a defined command syntax. At step 414, the command definition table is loaded to the mainframe address space. At step 416, the at least one test command of the plurality of test commands is executed by the mainframe address space. At step 418, at least one corresponding response of the plurality of corresponding responses is provided, by the command-based mainframe address space, based upon execution of the at least one test command.

Having described various embodiments of the invention, an exemplary computing environment suitable for implementing embodiments of the invention is now described. With reference to FIG. 5, an exemplary computing device is provided and referred to generally as computing device 500. The computing device 500 is but one example of a suitable computing environment and is not intended to suggest any limitation as to the scope of use or functionality of the invention. Neither should the computing device 500 be interpreted as having any dependency or requirement relating to any one or combination of components illustrated.

Embodiments of the invention can be described in the general context of computer code or machine-useable instructions, including computer-useable or computer-executable instructions, such as program modules, being executed by a computer or other machine, such as a personal data assistant, a smartphone, a tablet PC, or other handheld device. Generally, program modules, including routines, programs, objects, components, data structures, and the like, refer to code that performs particular tasks or implements particular abstract data types. Embodiments of the invention can be practiced in a variety of system configurations, including handheld devices, consumer electronics, general-purpose computers, more specialty computing devices. Embodiments of the invention can also be practiced in distributed computing environments where tasks are performed by remote-processing devices that are linked through a communications network. In a distributed computing environment, program modules can be located in both local and remote computer storage media including memory storage devices.

With reference to FIG. 5, computing device 500 includes a bus 510 that directly or indirectly couples the following devices: memory 512, one or more processors 514, one or more presentation components 516, one or more input/output (I/O) ports 518, one or more I/O components 520, and an illustrative power supply 522. The bus 510 represents what can be one or more buses (such as an address bus, data bus, or combination thereof). Although the various blocks of FIG. 5 are shown with lines for the sake of clarity, in reality, these blocks represent logical, not necessarily actual, components. For example, one can consider a presentation component such as a display device to be an I/O component. Also, processors have memory. The inventors hereof recognize that such is the nature of the art and reiterate that the diagram of FIG. 5 is merely illustrative of an exemplary computing device that can be used in connection with one or more embodiments of the present invention. Distinction is not made between such categories as “workstation,” “server,” “laptop,” “client device/system,” “user device,” “computing device,” or “mainframe system,” as all are contemplated within the scope of FIG. 5.

The computing device 500 typically includes a variety of computer-readable media. Computer-readable media can be any available media that can be accessed by the computing device 500 and includes volatile and nonvolatile, removable and non-removable media. By way of example, and not limitation, computer-readable media can comprise computer storage media and communication media. Computer storage media includes volatile and. nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by the computing device 500. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

The memory 512 includes computer storage media in the form of volatile and/or nonvolatile memory. The memory can be removable, non-removable, or a combination thereof. Exemplary hardware devices include solid-state memory, hard drives, optical-disc drives. The computing device 500 includes one or more processors 514 that read data from various entities such as the memory 512 or the I/O component(s) 520. The presentation component(s) 516 presents data indications to a user or other device. Exemplary presentation components include, by way of example only, a display device, a speaker, a printing component, a vibrating component, and the like.

The I/O port(s) 518 allows the computing device 500 to be logically coupled to other devices, including the 110 component(s) 520, some of which can be built in. Illustrative components include, by way of example only, a microphone, a joystick, game pad, a satellite dish, a scanner, a printer, a wireless device, and the like. Some embodiments of the computing device 500 can include one or more radio(s) 524 (or similar wireless communication components). The radio(s) 524 transmits and receives radio or wireless communications. The computing device 500 can be a wireless terminal adapted to receive communications and media over various wireless networks. The computing device 500 can communicate via wireless protocols, such as code division multiple access (“CDMA”), global system for mobiles (“GSM”), or time division multiple access (“TDMA”), as well as others, to communicate with other devices. The radio communications can be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection can include, by way of example and not limitation, a Wi-Fi® connection to a device (e.g., mobile hotspot) that provides access to a wireless communications network, such as a WLAN connection using the 802.11 protocol; a Bluetooth connection another computing device is a second example of a short-range connection, or a near-field communication connection. A long-range connection can include a connection using, by way of example and not limitation, one or more of CDMA, CPRS, GSM, TDMA, and 802.16 protocols.

Many different arrangements of the various components depicted, as well as components not shown, are possible without departing from the scope of the claims below. Embodiments of the present invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and can be employed without reference to other features and sub-combinations and are contemplated within the scope of the claims.

1. A computer-implemented method comprising:
receiving, at a mainframe address space hosting a mainframe test application, a command syntax, selected by a user or developer, for a mainframe Application Programming Interface (API) or service to be tested;
receiving, at the mainframe address space, at least one test command configured for invoking a functionality of the mainframe API or service to be tested, the at least one test command being received in the command syntax;
receiving, from the user or developer, at least one corresponding response to be provided by the mainframe test application in response to execution of the at least one test command, the at least one corresponding response being received in the command syntax;
executing, by the mainframe test application, the at least one test command; and
providing, by the mainframe address space, the at least one corresponding response based upon execution of the at least one test command.

2. The computer-implemented method of claim 1, wherein the mainframe test application mocks an environment for execution of the mainframe API or service to be tested.

3. The computer-implemented method of claim 2, wherein the at least one test command parameterizes the execution environment.

4. The method of claim 1,
wherein receiving the at least one test command configured for invoking the functionality of the mainframe API or service to be tested and receiving the at least one corresponding response to be provided by the mainframe test application in response to execution of the at least one test command comprises receiving, at the mainframe address space, a Command Definition Table,
and wherein the Command Definition Table includes a plurality of test commands and a plurality of corresponding responses provided in the command syntax, the plurality of test commands including the at least one test command and the plurality of corresponding responses including the at least one corresponding response.

5. The computer-implemented method of claim 1, wherein executing the at least one test command comprises executing an automated mainframe test that includes execution of the at least one test command.

6. The computer-implemented method of claim 5,
wherein the automated mainframe test is hosted by the mainframe address space,
and wherein the method further comprises issuing at least one modify command, to the mainframe test application, to execute the automated mainframe test.

7. The computer-implemented method of claim 5, further comprising:
receiving, from a testing framework in an integrated development environment (IDE) on a client device, at the mainframe address space, the automated mainframe test that includes execution of the at least one test command,
wherein providing, by the mainframe test application, the at least one corresponding response based upon execution of the at least one test command comprises providing the at least one corresponding response to the testing framework on the client device.

8. The computer-implemented method of claim 7, wherein receiving the automated mainframe test and providing the at least one corresponding response comprises receiving the automated mainframe test and providing the at least one corresponding response utilizing z/OSMF.

9. A computer-implemented method comprising:
creating a command-based mainframe address space hosting a mainframe test application that mocks entrance conditions for executing a mainframe Application Programming Interface (API) or service to be tested;
receiving, from a user or developer, a selection of a command syntax for the mainframe Application Programming Interface (API) or service to be tested;
receiving, at the command-based mainframe address space and in the command syntax, a test command configured for invoking a functionality of the mainframe API or service to be tested;
receiving, at the command-based mainframe address space and in the command syntax, a corresponding response to be provided, by the command-based mainframe address space, in response to execution of the test command;
executing, by the command-based mainframe address space, the test command; and
providing, by the mainframe test application, the corresponding response based upon execution of the test command.

10. The computer-implemented method of claim 9, wherein the test command parameterizes the execution environment.

11. The method of claim 9,
wherein receiving the test command configured for invoking the functionality of the mainframe API or service to be tested and receiving the corresponding response to be provided by the command-based mainframe test application in response to execution of the test command comprises receiving, at the mainframe address space, a Command Definition Table,
and wherein the Command Definition Table includes a plurality of test commands and a plurality of corresponding responses provided in the command syntax, the plurality of test commands including the test command and the plurality of corresponding responses including the corresponding response.

12. The computer-implemented method of claim 9, wherein executing the test command comprises executing an automated mainframe test that includes execution of the test command.

13. The computer-implemented method of claim 12,
wherein the automated mainframe test is hosted by the command-based mainframe address space,
and wherein the method further comprises issuing a modify command, to the mainframe test application, to execute the automated mainframe test.

14. The computer-implemented method of claim 12, further comprising:
receiving, from a testing framework in an integrated development environment (IDE) on a client device, at the command-based mainframe address space, the automated mainframe test that includes execution of the test command,
wherein providing, by the mainframe test application, the corresponding response based upon execution of the test command comprises providing the corresponding response to the testing framework on the client device.

15. The computer-implemented method of claim 14, wherein receiving the automated mainframe test and providing the corresponding response comprises receiving the automated mainframe test and providing the corresponding response utilizing z/OSMF.

16. A computerized system comprising:
a processor; and
a non-transitory computer storage medium storing computer-useable instructions that, when used by the processor, cause the processor to:
create a mainframe address space that mocks entrance conditions for executing a mainframe Application Programming Interface (API) or service to be tested;
generate a Command Definition Table that includes a plurality of test commands configured for invoking functionalities of the mainframe API or service to be tested and at least one corresponding response to be provided in response to execution of each of the plurality of test commands, the Command Definition Table being generated in a defined command syntax selected by a user;
load the Command Definition Table to the mainframe address space;
execute, by the mainframe address space, at least one test command of the plurality of test commands; and
provide, by the command-based mainframe address space, at least one corresponding response of the plurality of corresponding responses based upon execution of the at least one test command.

17. The computerized system of claim 16, wherein when used by the processor, the computer-useable instructions further cause the processor to execute the at least one test command by executing an automated mainframe test that includes execution of the at least one test command.

18. The computerized system of claim 17,
wherein the automated mainframe test is hosted by the mainframe address space,
and wherein, when used by the processor, the computer-useable instructions further cause the processor to issue a modify command, to the mainframe test application, to execute the automated mainframe test.

19. The computerized system of claim 17, wherein when used by the processor, the computer-useable instructions further cause the processor to:
receive, from a testing framework in an integrated development environment (IDE) on a client device, at the mainframe address space, the automated mainframe test,
wherein when used by the processor, the computer-useable instructions further cause the processor to provide, by the mainframe test application and based upon execution of the at least one test command, the at least one corresponding response to the testing framework on the client device.

20. The computerized system of claim 19, wherein, when used by the processor, the computer-useable instructions further cause the processor to receive the automated mainframe test and provide the at least one corresponding response to the testing framework on the client device utilizing z/OSMF.
